(19) United States
(12) Patent Application Publication
(10) Pub. No.: US 2009/0187412 A1
(43) Pub. Date: Jul. 23, 2009

(54) CORRELATION/RELATIONSHIP AND FORECASTING GENERATOR

(75) Inventors: Michael Thompson, Huntington Bay, NY (US); Steven Krull, East Meadow, NY (US)

Correspondence Address: KATTEN MUCHIN ROSENMAN LLP, 575 MADISON AVENUE, NEW YORK, NY, 10022-2585, US

(73) Assignee: IF ANALYTICS LLC, Muttontown, NY (US)

(21) Appl. No.: 12/016,382

(22) Filed: Jan. 18, 2008

(51) Int. Cl. G06Q 99/00

(52) U.S. Cl. 705/1

(57) ABSTRACT

A method, system and computer readable recording medium for forecasting financial data and economic data correlations including and executing the steps of selecting, from a database storing a plurality of data types, two or more two or more data types for forecasting, analyzing the two data types to determine the period of the data points in each selected data type, standardizing the time period of the selected data types to create time standardized data sets, converting the time standardized data sets into year over year percentage changes to create year over year data sets, creating a correlation matrix of the standardized year over year data sets, to determine the correlation coefficients between each of the selected two or more data types, and displaying the correlation matrix.

### FIELD OF THE INVENTION

The present invention relates generally to methods and systems for determining correlations/relationships between financial data and economic data, and particularly determining correlations/beta between different types of financial and economic data having different time periods for use in forecasting and simulation.

### BACKGROUND OF THE INVENTION

A variety of data is made available daily from a variety of sources that can be used for financial and economic analysis. Financial and economic data can be used to analyze companies, markets, countries, and regions to determine their health, effects of recent decisions, and forecast future trends.

Typically, financial information includes things such sales, losses, expenditures, dividends, profits, stock prices, etc. These are generally reported on a quarterly basis, often in the form of legally mandated quarterly reports, with the exception of stock price which may change second to second, but is often reported at a daily exchange close price.

Economic data is typically aggregated data used to show trends either globally, nationally, or even for different markets within a country or region. This information can be produced and issued on almost any time table from annually and quarterly, to weekly and daily. Often, as in the U.S., governments collect and report this data for use by financial institutions, corporations, and even individual investors.

The result of this data generated by the thousands of companies and hundreds of countries is that there is too much data to be effectively analyzed and used to produce usable metrics for forecasting and effective management of everything from stock exchanges, commodity prices, currency fluctuations, and other actions in the market place.

In an effort to analyze data, there have been a number of statistical methods developed that can be useful to reduce the amount of data that any individual has to review and the number of calculations that a person may have to perform to reach a reasonably accurate conclusion.

One known method of determining the significance of one variable to another is the determination of correlations coefficients. A commonly used correlation coefficient is Pearson's product-moment correlation coefficient. This correlation coefficient (r) compares two sets of data to ascertain whether there is a correlation between the data sets. The correlation coefficient's are between 1 and −1 with 1 representing strong positive correlation, −1 indicating strong negative correlation, and 0 indicating no correlation. This correlation coefficient provides indication at a glance whether two things covary perfectly, or near perfectly and whether positively or negatively. If the coefficient is, say, 0.80 or 0.90, the corresponding variables closely vary together in the same direction; if −0.80 or −0.90, they vary together in opposite directions.

A typical equation for determining this correlation coefficient is as follows:

$$r = \frac{N \sum xy - ( \sum x ) ( \sum y )}{\sqrt{[ N \sum {x}^{2} - {( \sum x )}^{2} ]} [ N \sum {y}^{2} - {( \sum y )}^{2} ]} \qquad Equation 1$$

Where:

N=the number of pairs of data;

Σxy=the sum of the products of the pairs of data;

Σx=the sum of x data;

Σ=the sum of y data;

Σx²=the sum of squared x data; and

Σy²=the sum of squared y data.

However, this correlation coefficient is only for two sets of data, and yields only a single correlation coefficient. As noted previously, in the area of financial and economic data there are nearly limitless types of data that can be compared. In order to even determine which of these sets of data provide some meaningful correlation the above calculation would have to be performed for each data set as compared to each other data set. If one is faced with even the minimal example of 10 data sets, this would require 45 correlation coefficient calculations. The number of correlations for a given number of data sets or variables (N) can be determined using the following formula:

$$\frac{N * ( N - 1 )}{2} = Number of correlations coefficients \qquad Equation 2$$

While this can be done by hand, there have long been available simple computer programs which can produce correlation matrices. A correlation matrix lists the variable or data set names down the first column and down the first row. The correlation matrix, then provides a correlation of any of the 10 variables to any other of the ten variables.

An example of such a matrix formed from 10 data sets or variables (C1-C10), each including some number of data points (for example 20) can be seen below:

$$\begin{matrix} & C 1 & C 2 & C 3 & C 4 & C 5 & C 6 & C 7 & C 8 & C 9 & C 10 \\ C 1 & 1.000 & & & & & & & & & \\ C 2 & 0.274 & 1.000 & & & & & & & & \\ C 3 & - 0.134 & - 0.269 & 1.000 & & & & & & & \\ C 4 & 0.201 & - 0.153 & 0.075 & 1.000 & & & & & & \\ C 5 & - 0.129 & 0.166 & 0.278 & - 0.011 & 1.000 & & & & & \\ C 6 & - 0.095 & 0.280 & - 0.348 & - 0.378 & - 0.009 & 1.000 & & & & \\ C 7 & 0.171 & - 0.122 & 0.288 & 0.086 & 0.193 & 0.002 & 1.000 & & & \\ C 8 & 0.219 & 0.242 & - 0.380 & - 0.227 & 0.551 & 0.324 & - 0.082 & 1.000 & & \\ C 9 & 0.518 & 0.238 & 0.002 & 0.082 & - 0.015 & 0.304 & 0.347 & - 0.013 & 1.000 & \\ C 10 & 0.299 & 0.568 & 0.156 & - 0.122 & - 0.106 & - 10.169 & 0.243 & 0.014 & 0.352 & 1.000\end{matrix}$$

Though shown here as only the bottom triangle, because this is a symmetric matrix, as all correlation matrices are, the top portion which is not shown, would be identical to the bottom portion.

Preparation of such a correlation matrix allows quick determination of which variables or data sets are dependent of each other and the degree to which they are dependent.

The basic correlation coefficient equation can also be weighted to produce different results, when a portion of data set from one or more of the variables is believed to be a more accurate representation. Thus if, for example, data which was generated in the last year is believed more relevant than data generated two years ago, the newer data can be weighted and then used in the equation above to produce a weighted correlation coefficient and ultimately a weighted correlation matrix.

Another basic method of comparing two data sets is to plot the data points and use least squares regression to fit a model to the data. The most common of these is linear least squares regression, where the basic formula is:

f( α̅, β̅)=β₀+β₁x₁+β₂x₂+ . . . Equation 3

Or stated differently:

Y=a+b₁X₁+b₂X₂+b₃X₃+b₄X₄+b₅X₅+e Equation 4

Where

Y is the dependent variable to be forecast

X are the independent variables

a is the y-intercept

b is the slope coefficient

An alternative to linear least squared regression is the use of weighted least squared regressions. Where the following formula is used to

$$Q = {\sum }_{i = 1}^{n} {{w}_{i} [ {y}_{i} - f ( {\overline{a}}_{i} ; \overline{β} ) ]}^{2} \qquad Equation 5$$

A weighted least squares regression is often used when the variability of one variable increases with increases in the second variable. This results in a poor fit for the curve when analyzing using traditional least squares regression. To account for this increase in error by applying a weight ωₜ. This weight is used to minimize the error estimates. In other words, the weights are used to determine how much each value of a dataset or variable influences the final.

However, although these techniques have been know for many years to statisticians and mathematicians, they have not been put into a practical method of analyzing both financial data and economic data to provide correlations and regressions allowing for useful analyses of these two different types of data. The present invention is directed to address this shortcoming of the known techniques.

### SUMMARY OF THE INVENTION

One aspect of the present invention is directed to a method for forecasting financial data and economic data correlations. The method includes steps of selecting, from a database storing a plurality of data types, two or more two or more data types for forecasting, analyzing the two data types to determine the time period of the data points in each selected data type, standardizing the time period of the selected data types to create time standardized data sets, converting the time standardized data sets into year over year percentage changes to create year over year data sets, creating a correlation matrix of the standardized year over year data sets, to determine the correlation coefficients between each of the selected two or more data types, and displaying the correlation matrix.

Another aspect of the present invention is directed to a computer readable recording medium having recorded thereon a computer program for forecasting financial data and economic data correlations. The program executes steps of selecting, from a database storing a plurality of data types, two or more two or more data types, analyzing the two data types to determine the time period of the data points in each selected data type, standardizing the time period of the selected data types to create time standardized data sets, converting the time standardized data sets into year over year percentage changes to create year over year data sets; creating a correlation matrix of the standardized year over year data sets to determine the correlation coefficients between each of the selected two or more data types, and displaying the correlation matrix.

Yet a further aspect of the present invention is directed to a system for forecasting financial data and economic data correlations. The system includes an updateable database stored on a recordable recording medium, the database storing a plurality of financial and economic data types, a computer terminal including a display and user interface connected to the data base; and a recordable recording medium storing a computer program. The computer program executes steps of selecting, from the database two or more two or more data types, analyzing the two data or more types to determine the period of the data points in each selected data type, standardizing the time period of the selected data types to create time standardized data sets for each data set pair, converting the time standardized data sets into year over year percentage changes to create year over year data sets, creating a correlation matrix of the standardized year over year data sets, to determine the correlation coefficients between each of the selected two or more data types, and displaying the correlation matrix on the display.

The present invention will now be described in more complete detail, with frequent reference being made to the figures identified below.

### BRIEF DESCRIPTION OF THE DRAWINGS

FIG. 1 is a flow chart depicting one process of the instant invention.

FIG. 2 is a continuation of the flow chart of FIG. 1.

FIG. 3 is a system view of one aspect of this proposed system.

### DETAILED DESCRIPTION

Though the mathematical calculations of forming a correlation matrix and conducting regressions, whether normal or weighted, are known, the following procedure differs from heretofore known systems and provides a system for identifying data types and variables having a correlation and enabling a user to perform the regressions for forecasting and predictive modeling.

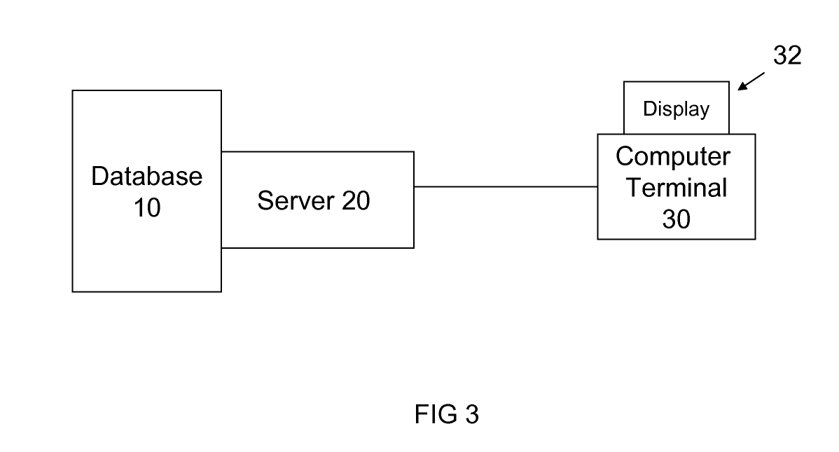

As a starting point, one portion of the system incorporates a database 10 in FIG. 3. The database 10 stores a variety of different types of data under two general categories. The first general category of data stored in the database is economic data and includes such items as GDP, inflation, jobs reports, housing reports, and any other economic indicators of the type generally developed and issued by governmental agencies and quasi-governmental entities both in the U.S. and abroad.

A second category of data consists of financial data, which are developed by companies and business entities and indicate performance of the company. These can include revenues, profit, profit margins, expenditures and any other data of the type typically found in quarterly financial reports of companies.

All of these data reside in the data base 10, which, though first populated with historical data, is updated on a regular basis. The timing of the updates is dependent upon the frequency of the data being updated, but can be regularly performed at any interval from daily to yearly. While shorter time periods are possible for items such as stock price, for comparison to other data types and the development of trends it will generally suffice to have even stock price updated with a daily close of exchange price.

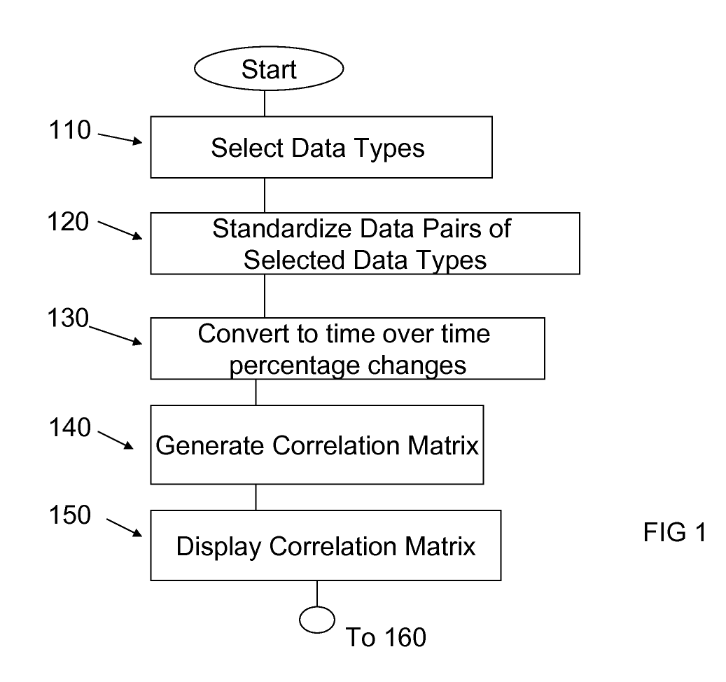

Once the database is populated, a user is then able to query the database to determine correlations between different types of economic and financial data. In one preferred embodiment, a user, who may be a customer of a company operating the database or an employee who will provide customers with reports based on inquiries, will select the specific types of data to be analyzed for correlation and inclusion in a correlation matrix, as shown in step 110 in FIG. 1.

The user can select any number of data types for use in creating the correlation matrix. As noted above, selection of, for example, 100 types of data will result in 4950 correlations between the data types using Equation 2.

As shown in FIG. 3, the database 10 may reside, for example on a server 20, and is accessed via a computer terminal 30 by the user (not shown). The computer terminal 30 includes a display 32, and operates a program (not shown) for manipulating the database 10, updating the database, and generating displays for the user.

The computer program, operating on the system 1, enables the user to enter the types of data for determining correlations and incorporating the correlations into a correlation matrix. The computer program enables standard types of correlations to be run as well as specific user requested correlations that may specify a specific type of data or a specific time period of interest. Thus for example if the user wishes to run correlations between all of the economic data which the U.S. government publishes quarterly against a variety of financial data of one specific company, the economic data may be selected through a group selection, and the financial data may be selected individually, or as part of a standard group selection for that company.

Once the data types are selected, the program extracts the data points for each data type over the specified time period from the database for conducting an individual correlation of the correlation matrix. These data points then need to be standardized such that they appear to have been generated at the same frequency, as shown in step 120. For example, in doing a long term analysis, the daily fluctuations of stock price, as compared to the U.S. monthly trade deficit with China must be standardized so that they appear at the same frequency. The instant system does this by adjusting the shorter frequency data to match the longer frequency data. In this case the daily stock price could be converted into a monthly average price or mean price for comparison to the monthly trade deficit. This type of standardization must be accomplished for all of the data set pairs for which correlation coefficients are to be determined. As a result, while the China trade deficit to stock price required standardization of the stock price to monthly average, within the same correlation matrix, the daily stock price could be standardized to a weekly average for comparison with a weekly reported data type, such as sales. Each of the selected data types will be compared to each other selected data types and they may each have a different period requiring different standardization.

Once the data points for each data or variable set are standardized for comparison to each other data type, according to one preferred embodiment of the instant invention, the data is converted to year-over-year percentage changes, as shown in step 130. This is done so that all regression and/or correlation calculations are done on the changes in the data and not based on the levels. This avoids the statistical issues that arise when using levels.

Next, using Equation 1, above, correlations for each of the data types to every other selected data type is calculated, and put into a correlation matrix, as directed by step 140. These correlations are preferably generated and displayed on the display terminal 32 of FIG. 3. The matrix will appear similar to that shown previously. In one preferred embodiment, the computer program operating on the system identifies the top correlations in an effort to highlight these as potentially desirable for further consideration and analysis.

As an alternative to and in conjunction with the calculation of the correlation matrix, it may be desirable to calculate a weighted correlation matrix. As discussed above, these are calculated by adding a weight or increase in value to certain portions of the data sets, the result is a change in the correlation. For example, for many correlations, more recent data, generated over the past year or six months may have more significance and weights may be added to these data such that are given more importance in the calculation of the correlation. These weighted correlations can be calculated simultaneously with the un-weighted correlation to provide two correlation matrices. The portion of any of the data sets can be determined manually by the user or by selection of standardized portions such as six months, the last year or the last five years.

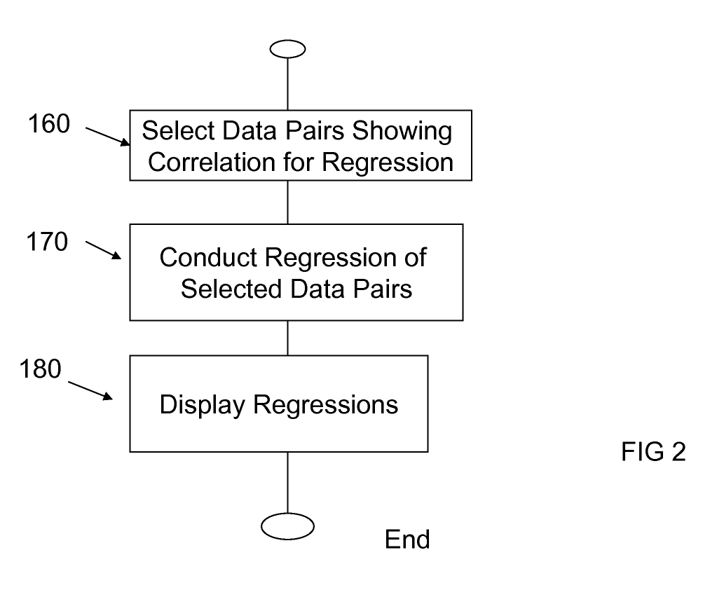

Now that the correlations are generated between the selected data types and displayed, data types which show correlations, whether positive or negative, may be selected by the user for calculation of regressions, as directed by step 160 of FIG. 2. The data sets for conducting of the regressions may be individually selected by the user or alternatively may be selected as part of a group. For example, regressions may be performed on all data showing a correlation of at least ±0.5, thus only those data types showing strong correlations may have regressions performed. Alternatively, other criteria for which data sets have regressions performed may be determined and incorporated into the program for selection by the user. The regressions can be performed on data sets showing correlation in either of the correlation matrices.

The calculation of regressions can then be performed on selected data set pairs or groups which have been shown to have a correlation in either the weighted or un-weighted correlation matrix. The calculation of the simple regressions for the data pairs or multiple regressions for data groups can be done using either Ordinary Least Squares (OLS) regression or Weighted Least Squares (WLS) regression using Equations 3 and 5 respectively. The result of these regressions may be plotted as lines through the data points of the two data sets. The plotted line has an intercept and a slope, and can be used for forecasting and/or scenario simulation analysis. The user may utilize the historical growth of the independent variables, which is a default forecast, or they may choose to input their own forecasted values using either OLS or WLS parameters. While plotting of the line may be useful for graphic representation, each regression also results in a simple linear equation, which can be used for calculating or estimating future performance, both are considered within step 180 of displaying regression in FIG. 2. The regressions may be limited to a user specified time period.

Having defined which financial data and economic data have correlations of at least a minimum threshold, and by performing regressions on these data whether weighted or un-weighted, a user is able to accurately estimate future performance using the historical information, and do so over a wide range of interrelated variable to more fully assess the relationship of the many variables.

The above description, including the specification and drawings, is illustrative and not restrictive. Many variations of the invention will become apparent to those of skill in the art upon review of this disclosure. Various features and aspects of the above-described disclosure may be used individually or jointly. Further, the present disclosure can be utilized in any number of environments and applications beyond those described herein without departing from the broader spirit and scope of the specification. The scope of the invention should, therefore, be determined not with reference to the above description, but instead should be determined with reference to the appended claims along with their full scope of equivalents. In addition, it will be recognized that the terms “comprising,” “including,” and “having,” as used herein, are specifically intended to be read as open-ended terms of art. The term “or” as used herein is not a logic operator in an exclusive sense unless explicitly described as such.

We claim:

1. A method for forecasting financial data and economic data correlations comprising the steps of:
selecting, from a database storing a plurality of data types, two or more two or more data types for forecasting;
analyzing data type pairs of the two or more selected data types to determine the period of the data points in each selected data type;
standardizing the time period of the data type pairs of the selected data types to create time standardized data sets;
converting the time standardized data sets into year over year percentage changes to create year over year data sets;
creating a correlation matrix of the standardized year over year data sets, to determine the correlation coefficients between each of the data type pairs of the selected two or more data types; and
displaying the correlation matrix.

2. The method of claim 1, further comprising a step of weighting at least a portion of data points in the selected at least two data types.

3. The method of claim 1, further comprising a step of selecting data type pairs having a correlation of at least a predetermine threshold.

4. The method of claim 2, further comprising a step of selecting data type pairs having a correlation of at least a predetermine threshold.

5. The method of claim 3, further comprising a step of calculating a regression of the data set pairs having a correlation of at least the predetermined threshold.

6. The method of claim 5, wherein the regression is performed using ordinary least squares regression.

7. The method of claim 5, wherein the regression is performed using weighted least squares regression.

8. The method of claim 4, further comprising a step of calculating a regression of the data set pairs having a correlation of at least the predetermined threshold.

9. The method of claim 8, wherein the regression is performed using ordinary least squares regression.

10. The method of claim 8, wherein the regression is performed using weighted least squares regression.

11. The method of claim 5, further comprising a step of displaying the regression.

12. The method of claim 8, further comprising a step of displaying the regression.

13. The method of claim 1, wherein the data points for each of the data types are updated regularly.

14. The method of claim 1, wherein new data types may be added by a user.

15. The method of claim 1, wherein at least one of the selected data types is economic information.

16. The method of claim 1, wherein at least one of the selected data types is financial information.

17. A computer readable recording medium having recorded thereon a computer program, the computer program for forecasting financial data and economic data correlations and executing the steps of:
selecting, from a database storing a plurality of data types, two or more data types;
analyzing the two or more selected data types to determine the period of the data points in each selected data type;
standardizing the time period of data type pairs of the two or more selected data types to create time standardized data sets;
converting the time standardized data sets into year over year percentage changes to create year over year data sets;
creating a correlation matrix of the standardized year over year data sets, to determine the correlation coefficients between each of the selected two or more data types; and
displaying the correlation matrix.

18. A system for forecasting financial data and economic data correlations comprising:
an updateable database stored on a computer readable recording medium, said database storing a plurality of financial and economic data types;
a computer terminal including a display and user interface connected to the data base; and
a recordable recording medium storing a computer program, the computer program executing steps of,
selecting, from the database two or more two or more data types;
analyzing the two or more data types to determine the period of the data points in each selected data type;
standardizing the time period of data type pairs of the selected data types to create time standardized data sets for each data type pair;
converting the time standardized data sets into year over year percentage changes to create year over year data sets;
creating a correlation matrix of the standardized year over year data sets, to determine the correlation coefficients between each of the selected two or more data types; and
displaying the correlation matrix on the display.
